(19) United States
(12) Patent Application Publication
(10) Pub. No.: US 2025/0315249 A1
(43) Pub. Date: Oct. 9, 2025

(54) DYNAMIC RESOURCE DETERMINATION FOR SYSTEM UPDATE

(71) Applicant: Intel Corporation, Santa Clara, CA (US)

(72) Inventors: Subrata BANIK, Bangalore (IN); Rajesh POORNACHANDRAN, Portland, OR (US); Vincent ZIMMER, Issaquah, WA (US); Utkarsh Y. KAKAIYA, El Dorado Hills, CA (US)

(73) Assignee: Intel Corporation, Santa Clara, CA (US)

(21) Appl. No.: 19/242,524

(22) Filed: Jun. 18, 2025

Related U.S. Application Data
(63) Continuation of application No. 18/557,897, filed on Oct. 27, 2023.

(30) Foreign Application Priority Data
Sep. 29, 2021 (IN) 202141044107

(51) Int. Cl. G06F 8/65; G06F 1/3212

(52) U.S. Cl. CPC G06F 8/65; G06F 1/3212

(57) ABSTRACT

The technology disclosed herein includes getting a system update configuration for managing updating of at least one of a software component and a firmware component of a computing system powered by a battery; determining an estimated system update time of usage of the battery to update the at least one of the software component and the firmware component based at least in part on the system update configuration; updating the at least one of the software component and the firmware component when resource requirements of the system update configuration are met and the estimated system update time is less than or equal to a minimum remaining time of usage of the battery; and deferring the updating when the resource requirements of the system update configuration are not met or the estimated system update time is greater than the minimum remaining time of usage of the battery.

### CLAIM OF PRIORITY

This Application is a continuation of and claims the benefit of and priority to U.S. application Ser. No. 18/557,897, entitled DYNAMIC RESOURCE DETERMINATION FOR SYSTEM UPDATE, by Subrata Banik, et al., filed Oct. 27, 2023, which under 35 U.S.C. § 371, claims the benefit of and priority to International Application No. PCT/US2022/031222, entitled DYNAMIC RESOURCE DETERMINATION FOR SYSTEM UPDATE, filed May 26, 2022, which claims the benefit of Indian Provisional Patent Application No. 202141044107, filed Sep. 29, 2021, which is incorporated by reference herein in its entirety.

### FIELD OF THE DISCLOSURE

This disclosure relates generally to updating software and/or firmware in a computing system, and more particularly, to dynamically determining if resources required for updating the software and/or firmware in a computing system are available.

### BACKGROUND

Updating software and/or firmware of a mobile computing system with limited battery capacity is challenged by at least the following factors: a) limited or no guaranteed residual battery lifetime; b) lack of resource guarantees resulting in inefficient use of system resources; c) most resources and power management capabilities are not available at a pre-operating system (OS) Unified Extensible Firmware Interface (UEFI) basic input/output (I/O) system (BIOS) level; and d) forced updates (e.g., those without explicit user agreement) disrupt the user experience. As a result, most mobile computing systems mandate rudimentary heuristic based residual battery requirements (to avoid bricking of a mobile computing system or incurring a midpoint failure during the update), resulting in poor user experience and inefficient use of platform resources. This might cause the end-user to not readily accept system updates and thus increase the chances of the mobile computing system being vulnerable to security threats and performance, thermal, and/or reliability setbacks.

### BRIEF DESCRIPTION OF THE DRAWINGS

FIG. 1 illustrates an update arrangement according to some embodiments.

FIG. 2 is a diagram of portions of a computing system according to some embodiments.

FIG. 3 is an illustration of a battery capacity view between a normal operations mode and a system update mode according to some embodiments.

FIG. 4 illustrates a system update configuration flow according to some embodiments.

FIGS. 5A and 5B illustrate a system update runtime operational flow according to some embodiments.

FIG. 6 is a flow diagram of system update processing according to some embodiments.

FIG. 7 is a block diagram of an example processor platform structured to execute and/or instantiate the machine-readable instructions and/or operations of FIGS. 4-6 to implement the apparatus discussed with reference to FIGS. 1-6.

FIG. 8 is a block diagram of an example implementation of the processor circuitry of FIG. 7.

FIG. 9 is a block diagram of another example implementation of the processor circuitry of FIG. 7.

FIG. 10 is a block diagram illustrating an example software distribution platform to distribute software such as the example machine readable instructions of FIG. 7 to hardware devices owned and/or operated by third parties.

The figures are not to scale. In general, the same reference numbers will be used throughout the drawing(s) and accompanying written description to refer to the same or like parts.

### DETAILED DESCRIPTION

The technology described herein provides a method and system for dynamic resource determination for efficient updating of one or more of software and firmware of a computing system powered by a battery (e.g., a mobile computing system). In an embodiment, this includes initiation of a system update only after ensuring required resources are available and the system update is guaranteed, otherwise the user or system administrator (admin) is prohibited from accepting and performing the system update. The system update is then deferred until the required resource criteria is met. The technology described herein includes a method to guarantee the availability of those required resources dynamically for improved Quality of Service (QOS) while performing critical tasks such as system updates.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and/or other changes may be made without departing from the scope of the subject matter of this disclosure. The following detailed description is, therefore, provided to describe example implementations and not to be taken as limiting on the scope of the subject matter described in this disclosure. Certain features from different aspects of the following description may be combined to form yet new aspects of the subject matter discussed below.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real-world imperfections.

As used herein, “processor circuitry” or “hardware resources” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

As used herein, a computing system can be, for example, a server, a personal computer, a workstation, a self-learning machine (e.g., a neural network), a mobile device (e.g., a cell phone, a smart phone, a tablet (such as an iPad™)), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

In many mobile computing systems (including those computing systems often operating with power obtained from a battery), an “in-field” firmware and/or OS update is often needed and a good user experience to ensure a robust system update is an indicator towards platform stability of a computing system. One key performance indicator (KPI) of a good user experience is to ensure a successful system update with optimized system resource usage.

With the modern mobile computing systems, power optimization is limited to Operating System Power Management (OSPM) and the pre-OS computing environment lacks methods to configure the major power consumers of the mobile computing system during a task such as a system update. The predictability in system update processing is missing along with a guaranteed reservation of resources to ensure a successful system update. Due to the lack of such knowledge, a mobile computing system might exhaust required resources prior to completing a system update and this may result in a broken mobile computing system (e.g., due to the battery going below a minimum threshold level for a system update, typically and crudely set at approximately 50% remaining battery life).

Thus, the current system update evolution process lacks predictability for determining the resources required for a successful system update. Also, there is no known mechanism to prohibit the user from accepting a system update as a result of analysing the system resource sustainability for ensuring QoS while performing critical tasks, such as system update, without resulting in a potentially inoperable mobile computing system.

The technology described herein includes at least one additional component in an operating system (OS) or a basic input/output system (BIOS), called a predictive resource evaluator herein, to perform the prediction based on available system resources and calculate the estimated system update time based at least in part on an updater metadata file (e.g., included as part of an updater package). If the estimated system update time is greater than the minimum remaining time of usage of the battery in the current operating mode (referenced herein as B_min), then the system update process is deferred for a later time. This process ensures a guaranteed level of required resources (including battery life) needed to successfully perform a system update is available prior to initiating the system update process.

Additionally, this innovation proposes a new operating mode, called Min-Power Update, to ensure minimum system power usages while performing initialization of a hardware device in a mode where a dynamic power and thermal management capability is not yet available. This method includes consideration by the system update process of a maximum threshold for system resources, such as a remaining time of usage of the battery in the current operating mode (referenced herein as B_max). According to an implementation, a system update is performed only if the estimated system update time is between B_min and B_max. In an embodiment, selected intellectual property (IP) blocks of computing hardware may be set to the Min-Power-Update power state based at least in part on a user/admin configuration.

This method ensures that an initiated system update never results in a partial system update or an inoperable mobile computing system, nor does the method waste system resources (e.g., network bandwidth, battery usage, etc.).

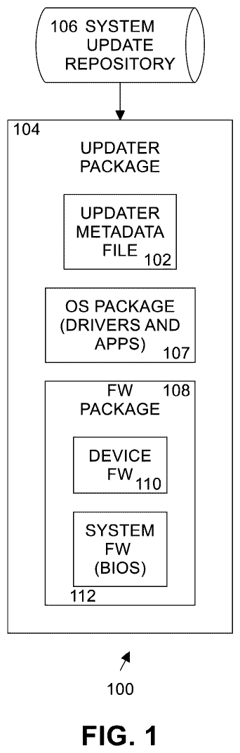

FIG. 1 is a diagram of an update arrangement 100 according to some embodiments. Updater package 104 may be a file obtained, either locally or remotely, from a system update repository 106 (e.g., a database of updater packages). In some embodiments, updater metadata file 102 of update package 104 contains an indication of a number of system reboots required to perform an update, thereby allowing a predictive resource evaluator 204 (as described below) to calculate an estimated update time, including the time needed to reboot the system. In other embodiments, updater metadata file 102 may include update time information for one or more previous versions of the firmware and/or software being updated. In another embodiment, update time information may be updated and obtained via known crowd-sourcing techniques comparing an estimated time and an actual time to update a similar computing system configuration. For example, when updating from v0.2 software to v0.5 software, the computing system may take seven minutes to perform the update on a 1 gigahertz (GHz) single processing core but may take only two minutes when updating from v0.4 software to v0.5 software. This information allows the predictive resource evaluator 204 to calculate the predicted update time knowing both the current version of software installed on the system and the newer version being upgraded on the system.

In some embodiments, updater metadata file 102 contains information about fine-grained update stages and/or times, thereby enabling performance of a multi-staged/phased update. For example, if updater package 104 includes updates for eight different intellectual property (IP) blocks (where an IP block is a hardware resource in a mobile computing system), the update may take five minutes to update three IP blocks, 12 minutes to update five IP blocks, and 20 minutes to update all eight IP blocks. For low battery-life situations and/or projections, the predictive resource evaluator 204 may use this information to perform a “partial” upgrade without cancelling the entire system update. For example, a system update for only three IP blocks may be performed given the current battery life situation of the mobile computing system and the rest of the upgrade may be performed once the battery of the mobile computing system is re-charged.

Updater package 104 may include OS package 107, including code for one or more drivers and applications (apps), and firmware (FW) package 108. FW package 108 may include code for zero or more device FW 110 and zero or more system FW 112 (BIOS).

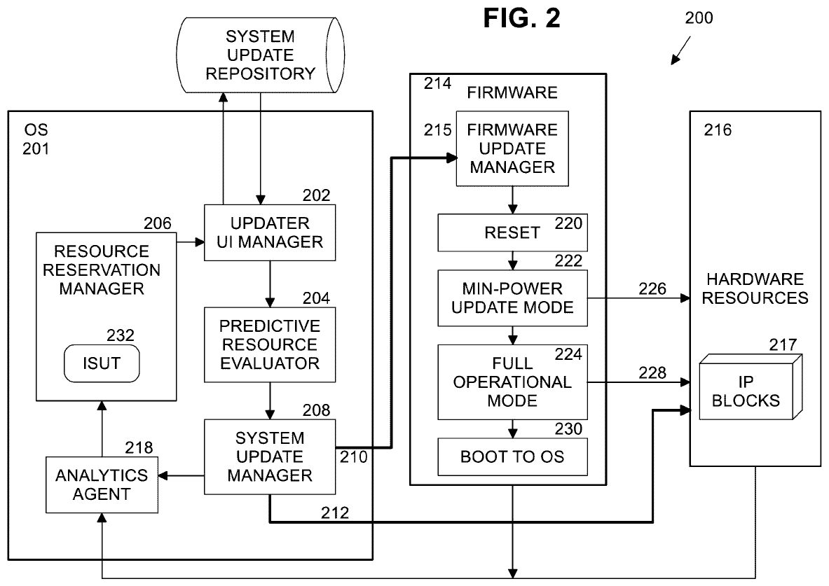

FIG. 2 is a diagram of portions of a computing system 200 according to some embodiments. In an embodiment, computing system 200 is a mobile computing system reliant on power from a battery. The technology disclosed herein includes 1) an updater user interface (UI) manager 202 for configuration of a Min-Power-Update mode 222 and a notification capability; 2) a predictive resource evaluator 204; 3) a resource reservation manager 206 for the Min-Power-Update mode; 4) a system update manager 208; 5) a system update 226; and 6) reboot operations 210, 212 of firmware 214 and hardware resources 216, respectively, to a Min-Power-Update mode (to perform system update 226 of hardware resources 216) and then a transition to Full-Operational mode 224.

Embodiments propose a dynamic methodology in the system update process where one or more OS-based components analyze the availability and level of hardware resources 216 prior to initiating a system update 226 and pursue the system update only when the availability and level of hardware resources is sufficient, otherwise the system update is deferred until the resource criteria is met. This provides flexibility for triggering a system update based on dynamically obtained knowledge of computing system resources rather than initiating the system update blindly (which may result in an inoperable computing system if sufficient resources are not available, leading to a poor user experience).

In one implementation, the components to support this dynamic capability are integrated into OS 201. In another implementation, the components to support this dynamic capability are integrated into the BIOS (e.g., FW 214).

Updater UI manager 202 obtains updater package 104 containing updater metadata file 102 from system update repository 106. Updater metadata file 102 comprises metadata which includes hints about a FW or system software update with or without crowd-sourced update time information. Predictive resource evaluator 204 determines the estimated duration for completion of the system update by understanding the type of the system update and the resources needed to perform the system update (e.g., firmware update, OS update, operating frequency, pre-boot single processing core versus multiple processing cores environment, cellular communications, WiFi communications, Bluetooth® communications, other network communications, etc.). Resource reservation manager 206 defines a system resource usage model by creating maximum and minimum resource usage boundaries after optimizing system resources by configuring those resources to a minimum operable power (where the remaining power level of the computing system doesn't have an impact on the successful performance of a system update). System update manager 208 directs firmware update manager 215 of firmware 214 perform a firmware update 226 if a predictive resource usage limit is within resource boundaries (that is, between a maximum and a minimum remaining battery life), otherwise the end-user and/or system update repository 106 is notified that resources available for the system are not sufficient to initiate the firmware update. Firmware 214 includes reset 220, min-power update mode 222, full operational mode 224, and boot to OS 230.

System update manager 208 starts 210 the min-power update by rebooting firmware 214 to min-power update mode (via reset 220). System update manager 208 also sets 212 a runtime update IP state to min-power update mode in hardware resources 216. Min-power update mode 222 performs system update 226 while in min-power update mode. Firmware 214 restores hardware resources 216 to full operational mode via operation 228. Analytics agent 218 calculates min-power update resource requirements and sends this information to resource reservation manager 206. In one implementation, min-power update resource requirements include a list of IP blocks that need to be in an active DO state to accomplish user functionality (such as media playback, global position system (GPS) or phone application (e.g., for a phone application, the computing system may need to preserve long term evolution (LTE) capabilities, a display, a microphone, audio, etc.)). Analytics agent 218 may provide analytical insights from platform update telemetry. In one embodiment includes how well the predictive resource evaluator 204 was able to predict the estimate update time the time versus the actual time to perform the update. Based on insights of the analytics agent 218, resource reservation manager 206 updates Informative System Update Table (ISUT 232) in terms of which IP blocks, memory and/or interconnect circuitry that needs to be in a specific power state for the pre-boot OS to enforce during a computing system platform. In an embodiment, the resource reservation manager 206 stores, in ISUT 232, identification of selected hardware IP blocks 217 of the computing system and sets the IP blocks to a minimum power update mode (e.g., Min-Power-Update mode) based at least in part on a user or admin configuration.

In an embodiment, this technology may be implemented in three phases. In phase one, the estimated system update resource availability is predicted based at least in part on the type of system update and required resources (such as firmware update, OS update, operating frequency, pre-boot single core versus multiple core environment, etc.). In phase two, the resource usage maximum and minimum boundary (e.g., maximum remaining battery life and minimum remaining battery life needed to perform the system update) are determined managing the available and required resources in optimal power states (for example, a phone application requires a subset of resources that needs to be in an active state while the rest of the computing system can be in a power save state) In phase three, a system update user communication and notification methodology are determined that only allows a system update to be initiated if a predictive resource usage limit is within resource boundaries (e.g., between a minimum remaining battery life and a maximum). Otherwise, the end-user is notified that available system resources may not be enough to initiate the system update and the system update is deferred until a later time.

In phase one, the availability of system update resources is determined before deciding whether to initiate a system update. In one implementation, a system update is performed by implementing a state machine to complete the update process. First, updater UI manager 202 downloads the system update. In this step, updater UI manager 202 downloads updater package 104 from system update repository 106, where updater metadata file 102 information which further helps to calculate the estimated system update time (e.g., time taken to install 1% of system update as per predictive application) for given available resources from past updates and/or crowd sourced information from other similar computing systems. In an embodiment, update metadata file 102 includes information about the system update time based on a particular frequency in a single processing core computing environment (provided by the OEM while sending the updater package 104). System update repository 106 may be provided by an original equipment manufacturer (OEM) or OS vendor. System resources used in this step may include network bandwidth and battery usage. Hence, these resources need to be included in a calculation of an accurate estimated time for downloading the system update.

Next, the estimated time to download the system update based on network bandwidth is determined. In an embodiment, the size of updater package 104 (obtained using an application program interface (API)) and the current downloading bandwidth of the computing system are used to calculate the estimated download time. In one implementation, the estimated updater package download time (in seconds)=Updater package size (in megabytes (MB))/network bandwidth (in MB/seconds). The estimated updater package download time is referred to below as X.

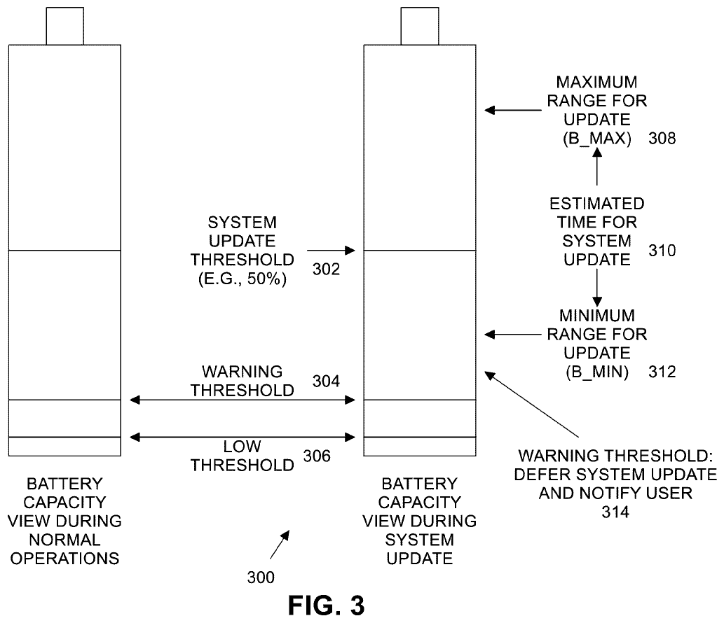

On some computing systems (such as a laptop personal computer (PC)), the battery is an important sub-system and any task running while the system is in battery mode has an impact on battery life. FIG. 3 is an illustration of a battery capacity view 300 between a regular operating mode and a system update mode according to some embodiments. Typically, a threshold 302 for performance of a system update is set to approximately 50% of the remaining battery life. Typically, the battery system has other thresholds, such as an OEM-designed threshold 304 for warning (W) and threshold 306 for low level (L) for designed safety. Hence, the maximum battery capacity threshold for normal (regular) operation is =(Battery designed maximum capacity−Design safety margin). The threshold for normal operation is referred to below as N.

For a system update, the system has an additional threshold while operating in battery mode, called a threshold for system update=(Battery designed maximum capacity−Design safety margin)×50%. The system update threshold is referred to below as T.

Battery management policies in some computing systems are managed by an Advanced Configuration and Power Interface (ACPI)-compatible OS. An ACPI-compatible battery device implements a Control Method Battery interface implemented inside BIOS ACPI machine language (AML) code. The Control Method Battery reports the present battery drain rate. The present battery drain rate is referred to below as R. Hence, the following calculation determines the minimum battery availability estimation for downloading system update as D: D (in seconds)=(N−(R*X))/R.

For example, assume a system update package size is 1 gigabyte (GB) and network bandwidth at the computing system is 10 megabytes per second (Mbps), hence ‘X’ would be 100 seconds. Assume the present battery consumption during the download process R is 5000 milliamps per hour (mAh) and the OEM battery designed capacity (N) is 35,000 mAh. Hence, the predictive system battery minimum availability time for a successful downloading system update is: D (in seconds)=((35,000−(5,000*0.0277778))/5,000)*60*60=˜25,100 seconds (˜6.97 hours).

As shown in FIG. 3, an estimated time for system update 310 must be between a minimum remaining time of usage of the battery (e.g., minimum range for update) B_min 312 and a maximum range for update B_max 308. If the estimated time for system update 310 results in the battery going below minimum range for update (B_min) 312 then initiation of the system update is deferred and the user is notified.

Next, system update manager 208 installs the downloaded binaries of updater package 104 based on the type of the system update (e.g., a firmware update and/or OS update, and optionally including information describing the underlying computing environment for initiating the update, such as a multithreaded environment or a single threaded environment, etc.).

In one embodiment, an Informative System Update Table (ISUT) 232 may be created and maintained by resource reservation manager 206 to store information relating to the system update decision-making process. The ISUT 232 stores learning feedback information from the OS 201 to the BIOS based at least in part on insights from analytics agent 218. In one implementation, ISUT 232 is stored in memory accessible by the resource reservation manager. An example of an ISUT data structure is shown below.

```
Typedef struct {
  UINT8 FW_Update : 1; // Set to inform that FW update is available
  UINT8 OS_Update : 1; // Set to inform that OS update is available
  UINT 8 Multi_cores_enable : 1; // Update initiated in multithreaded
environment
  UINT 8 core_count : 5; // Maximum cores available for initiating update
} INFORMATIVE_TASK;
Typedef struct {
  UINT32 Signature; // Valid signature as “FEEDC0DE”
  INFORMATIVE_TASK task; // Define informative task prior to system
update process
}INFORMATIVE_SYSTEM_UPDATE_TABLE;
```

In an embodiment, the ISUT may be digitally signed based on a platform ownership key in a trusted execution environment (TEE) so that firmware 214 can ensure that the ISUT is an authorized update, versus malware creating a malformed ISUT and launching a potential denial of service attack against the computing system (e.g., claiming there is sufficient power but instead invoking the update on a nearly power-depleted computing system).

At a first boot, the firmware 214 (e.g., a BIOS) allocates an INFORMATIVE_OPTIMIZATION_TABLE structure into real time clock (RTC) memory (not shown in FIG. 2) and initializes the table signature as “FEEDCODE”. During consecutive boot phases, the BIOS reads this memory region to check if the signature is valid. Upon verification, the BIOS checks if any informative entry has already been made by reading an “FW_Update” data variable of ISUT 232 to know the type of the system update. Based on the informative tasks bit definition (as shown in ISUT 232), an estimation can be made to determine the minimum battery resource availability needed to successfully complete installation of a system update. As shown in the example ISUT 232, if the FW_Update bit is set in the ISUT data structure, this means “keep system resource usage at B_Min level and trigger system update”.

In an embodiment, predictive resource evaluator 204 may communicate with various OS 201 services to retrieve information, such operating CPU frequency and the number of available cores, to calculate the estimated system update time for a 1% update. This information is useful to calculate the minimum remaining time of usage of the battery needed for installing a system update, referred to below as I. Thus, I (in seconds)=((100−i)*x)/C; where: i=pending system update in percentage, x=time taken to install 1% of system update as per predictive resource evaluator 204. The available core counts for installing update (C)=(ISUT. OS_Update)?((ISUT. Multi_cores_enable)?ISUT. core_count: 1):1.

The minimum time of usage of the battery needed for a successful system update is the total time to download the update and the time to install the system update: estimated system update time (P)=D+I.

In phase two, system resource usage boundaries are determined. An ACPI compliant system BIOS has control methods to retrieve battery usage information. In a typical scenario, an ACPI control method reports the Present Drain Rate (R) for calculating the minimum battery life in current working mode. This formula is used to calculate the minimum boundary if Battery Remaining Capacity (B) is greater or equal to Threshold for system update (T): minimum remaining time of usage of the battery (B_min)=((B−T)/Present Battery Drain Rate (R).

In an embodiment, an Intra-Power-Corrector (IPC) factor may be calculated as a ratio of the battery drain savings between the Full Operational Mode versus the Min Power Update mode specific to the computing system under consideration.

The IPC ratio may be applied to calculate the maximum range for update 308: Remaining Battery Life Maximum Threshold (B_max)=B_min*IPC.

For example, if Battery Remaining Capacity (B) is 25,000 mAh and Present Battery Drain Rate (R) is 7,500 mAh, and the OEM design battery threshold (T) is 17,500 mAh. Then B_min and B_max for a system update would approximately 60 minutes and 214 minutes, respectively.

At phase three, predictive resource evaluator 204 uses information gathered in phases one and two to decide whether to perform the system update or defer the system update for a later time when the required resources are available. Table 1 illustrates factors and decisions that may be made.

TABLE 1

| System | | | |
|---|---|---|---|
| Environment | Condition | Logic | Decision |
| System on Battery | Minimum remaining time | B_min < T | Defer the system |
| | of usage of battery | | update for later time |
| | threshold is less than | | and notify user to |
| | Threshold for system | | connect charger. |
| | update. | | |
| | Estimated updater package | D < T | Defer the system |
| | download time is less than | | update for later time |
| | Threshold for system | | and notify user to |
| | update. | | connect charger. |
| | Estimated system update | B_max > P > | Switch to negative |
| | time is greater than | B_min | contrast display |
| | minimum remaining time | | polarity for system |
| | of usage of the battery and | | update notification |
| | less than maximum | | and trigger system |
| | threshold. | | update. After |
| | | | successful system |
| | | | update, restore to |
| | | | normal display |
| | | | polarity. |
| | Estimated system update | P > B_max > | Defer the system |
| | time is greater than both | B_min | update for later time |
| | maximum threshold and | | and notify user to |
| | minimum remaining time | | connect charger. |
| | of usage of the battery. | | |
| System on AC | ISUT table identify system | ISUT.FW_Update ∥ | Keep system |
| power | update | ISUT.OS_Update | resource usage at |
| | | | B_Min level and |
| | | | trigger system update |
| | Battery level is between | B_Min < L < W | Switch to Negative |
| | low and warning threshold | | Contrast Polarity for |
| | level. | | System Update |
| | | | Notification and |
| | | | Trigger System |
| | | | Update. |

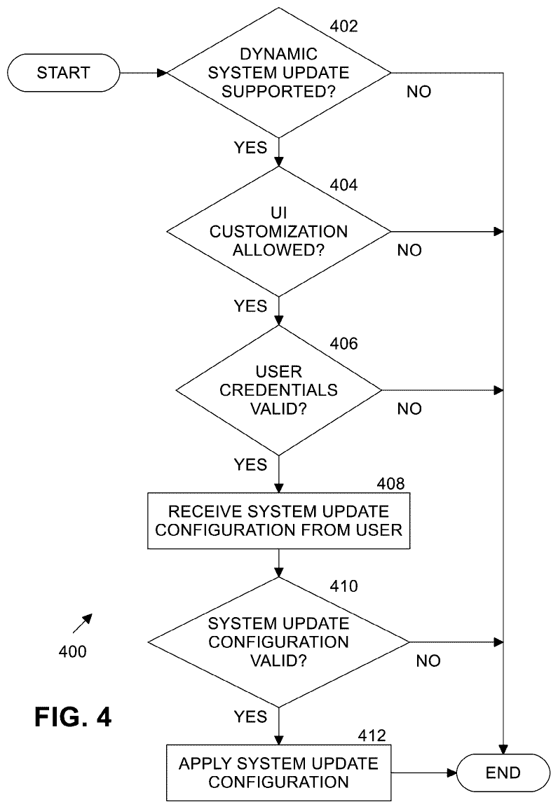

FIG. 4 illustrates a system update configuration flow 400 according to some embodiments. Once computing system 200 is booted, a system update configuration 240 may be defined and/or selected prior to running application programs. In an embodiment, system update configuration 240 comprises a snapshot of information relating to successfully verified and installed updates on the computing system. In an example, the system update configuration may be a default configuration selected for the user by provider (e.g., OEM) of the computing system provider. This may be overridden with valid user credentials using a UI dashboard by updater UI manager 202. As used herein, updater metadata file 102 includes information provided by the system update repository 106 based on the contents of the updater package 104 along with any crowd-sourced information.

In an embodiment, the processing of flow 400 may be performed, at least in part, by OS 201 and firmware 214. At block 402, OS 201 determines if a dynamic system update capability (as described herein) is supported. If dynamic system update is not supported, system update configuration processing ends. If dynamic system update capability is supported, then at block 404, updater UI manager 202 of OS 201 determines if UI customization of a system update configuration 240 is allowed. If customization is not allowed, system update configuration processing ends. In an embodiment, customization may include providing the capability for a user of computing system 200 to select and/or specify one or more settings relating to configuration of the system update, such as don't let the current GPS application or phone application be disturbed because user is using a navigation capability or in engaged in a phone call. If customization is allowed, then at block 406 updater UI manager 202 determines if credentials of the user are valid. That is, the computing system determines if the user attempting to change the system update configuration 240 is authorized to do so. If the user is unauthorized, system update configuration processing ends. If the user is authorized, at block 408 updater UI manager 202 receives one or more settings and/or selections to change the system update configuration 240 from the user. In an embodiment, this may include presenting a snapshot of the current system update configuration parameters to the user and accepting input selections to update one or more system update configuration parameters. At block 410, updater UI manager 202 determines if the updated system update configuration 240 is valid. If the updated system update configuration 240 is invalid, system update configuration processing ends. If the updated system update configuration 240 is valid, the updated system update configuration is applied to the computing system at block 412. Any subsequent system updates (e.g., of OS 201 and/or firmware 214) will use the updated system configuration 240.

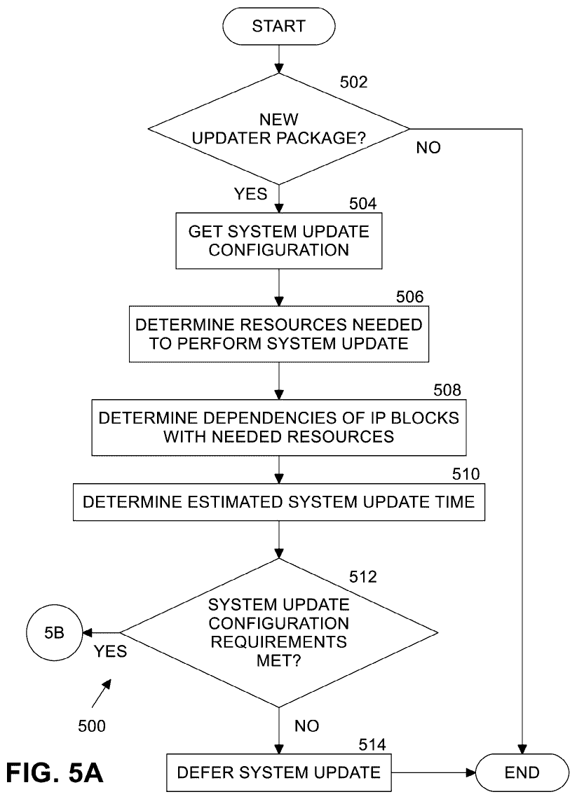

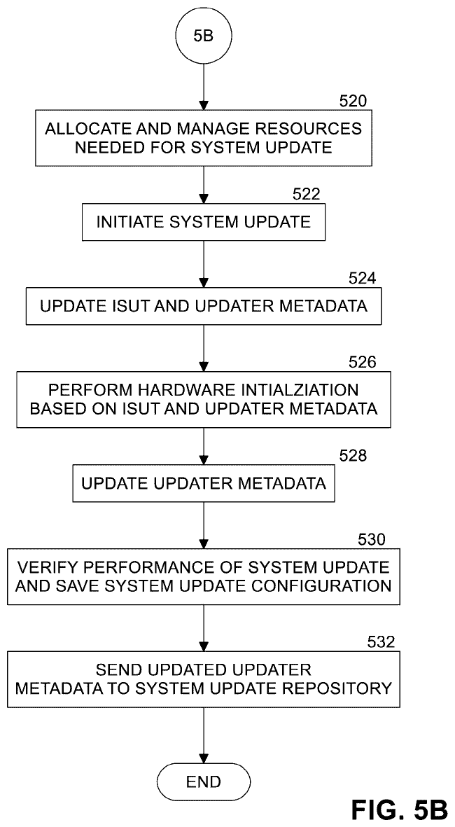

FIGS. 5A and 5B illustrate a system update runtime operational flow 500 according to some embodiments. If OS 201 detects that a new updater package 104 is available from the system update repository 106 at block 502, then at block 504 updater UI manager 202 gets the system update configuration. In an embodiment, the system update configuration 240 may be managed by platform Trusted Execution Environment (TEE) of the computing system 200, by the OS 201 or within a cache of update UI manager 202.

If no new updater package 104 is available, system update runtime operational processing ends. At block 506, predictive resource evaluator 204 determines the resources of the computing system needed to perform the system update. Resources may include battery power, communications capabilities (e.g., global positioning system (GPS), cellular communications, WiFi), audio or video playback, camera, display, etc.). At block 508, predictive resource evaluator 204 determines dependencies of one or more intellectual property (IP) blocks 217 of hardware resources 216 with the resources needed to perform the system update. In an embodiment, the dependencies are represented as a dependency graph. In an embodiment, the dependency graph indicates which IP block(s) must be active and which IP block(s) must be quiesced during the system update. At block 510, predictive resource evaluator 204 determines an estimated system update time (e.g., P, the time needed to download the updater package (D) and perform the system update (I)). In an embodiment, the estimated system update time is determined using one or more of the dependency graph and metadata from updater metadata file 102. In one example, metadata may include:

```
Metadata structure {
  Update Version Info V;
  Avg. Update Time History H;
  Crowd Source Update Time for Version V T;
}
```

At block 512, predictive resource evaluator 204 determines if the requirements of the system update configuration are met. In an embodiment, this may be achieved by comparing the estimated system update time (P) to the minimum remaining time of usage of the battery (B_min). For example, predictive resource evaluator 204 may determine if the estimated system update time is greater than B_min. If the system update configuration requirements are not met (including required remaining battery life and other required resources), then initiation of the system update is deferred at block 514 and system update runtime operational processing ends. Otherwise, the system update may proceed via connector 5B to block 520 of FIG. 5B. At block 520, resource reservation manager 206 of OS 201 allocates and manages resources (e.g., running required cores at a specified frequency, reserving needed any memory bandwidth, ensuring IP blocks are in a specified power/clock state, etc.) needed for performing the system update. In an embodiment, the allocation and management are performed based at least in part on the dependency graph and the needed remaining battery time (e.g., estimated system update time P) (without violating the B_min threshold).

At block 522, system update manager 208 initiates the system update (e.g., via operations 210 of FIG. 2). After the system update is initiated, system update manager 208 at block 524 updates ISUT 232 and updates updater metadata file 102. In an embodiment, updates to ISUT 232 by system update manager 208 may include specifying the operational states of the computing system based on the user constraints (e.g., keeping local audio playback, wherein resources other than audio IP block(s) and associated memory & speakers are set to a power gated state in a pre-OS computing environment). In another embodiment, system update manager 208 updates the updater metadata file 102 with the platform snapshot in terms of B_Min, B_Max, current update time, resources state, etc. as record keeping for future updates. As part of the initiation of the system update, firmware 214 is set to a Min-Power-Update mode 222. At block 526, system update manager 208 directs (via operation 212) to perform hardware resources 216 initialization based at least in part on ISUT 232, updater metadata file 102, and the system update configuration. At block 528, system update manager 208 updates the system update metadata in the updater metadata file 102. In an embodiment, this includes B_Min, B_Max, current update time, resources state, etc. At block 530, system update manager 208 verifies successful performance of the system update and, optionally, saves the updated system update configuration. In an embodiment, this may include analytics agent 218 retrieving the power and performance counters from the IP blocks 217 in hardware resources 216 to provide insights for future resource reservations to resource reservation manager 206.

Storage or saving of the updated system configuration 240 is dependent on an implementation. Examples include storing the system update configuration in non-volatile memory express (NVMe) memory devices, serial peripheral interface (SPI) NOR Flash memory, an OS disk partition, etc., with or without TEE protection. In an embodiment, metadata useful for future system updates may include current upgraded system software/FW Version, size, checksum, digital signature, update time stamp, verification result, Min Power Mode, resource reservation table, ISUT 232, and updater metadata file 102. Depending on the implementation choice, this information may be stored locally, or in the cloud.

At block 532, system update manager 208 sends the updated system update metadata to system update repository 106 (via resource reservation manager 206 and/or updater UI manager 202) for use in future system updates (firmware and/or software).

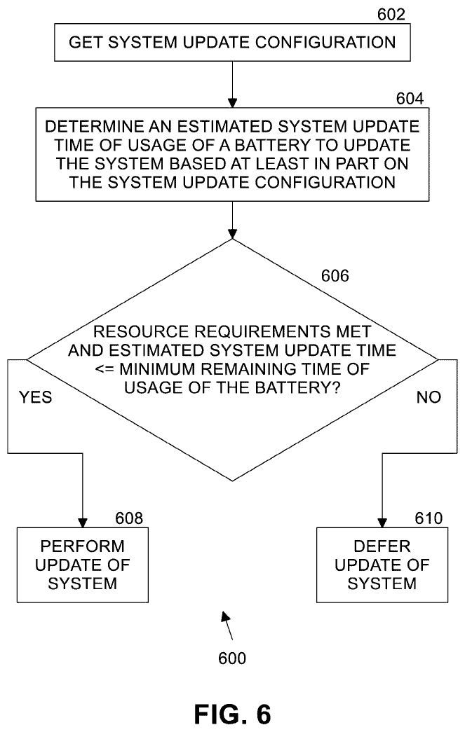

FIG. 6 is a flow diagram of system update processing 600 according to some embodiments. At block 602, updater UI manager 202 of OS 201 gets a system update configuration 240. In an embodiment, the system update configuration is included in updater metadata file 102 of updater package 104. In an embodiment, system update configuration 240 is stored by the OS 201. In an embodiment, the system update configuration 240 specifies the resources required for updating zero or more software components (e.g., at least a portion of OS 201 in OS package 107), and/or zero or more firmware (FW) components (e.g., system FW 112 (BIOS) and device FW 110 in FW package 108). The total number of software components and firmware components to be updated is one or more (e.g., any number of software components and any number of software components as long as the total is at least one). At block 604 predictive resource evaluator 204 of OS 201 determines an estimated system update time (e.g., P) of usage of a battery to update the zero or more of software components and zero or more firmware components based at least in part on the system update configuration. At block 606, predictive resource evaluator 204 determines if resource requirements of the system update configuration are met and the estimated system update time (e.g., P) is less than or equal to the minimum remaining time of usage of the battery (e.g., B_min). If so, at block 608, system update manager 208 of OS 201 performs the update of the zero or more software components and the zero or more firmware components. If not, at block 610, system update manager 208 defers the update of the zero or more software components and the zero or more firmware components to a later time.

While an example manner of implementing the technology described herein is illustrated in FIGS. 1-6, one or more of the elements, processes, and/or devices illustrated in FIGS. 1-6 may be combined, divided, re-arranged, omitted, eliminated, and/or implemented in any other way. Further, the example hardware resources 216 may be implemented by hardware, software, firmware, and/or any combination of hardware, software, and/or firmware. Thus, for example, any of the hardware resources 216 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example hardware resources is/are hereby expressly defined to include a non-transitory computer readable storage device or storage disk such as a memory, a digital versatile disk (DVD), a compact disk (CD), a Blu-ray disk, etc., including the software and/or firmware. Further still, the example circuitry of FIG. 2 may include one or more elements, processes, and/or devices in addition to, or instead of, those illustrated in FIG. 2, and/or may include more than one of any or all the illustrated elements, processes and devices.

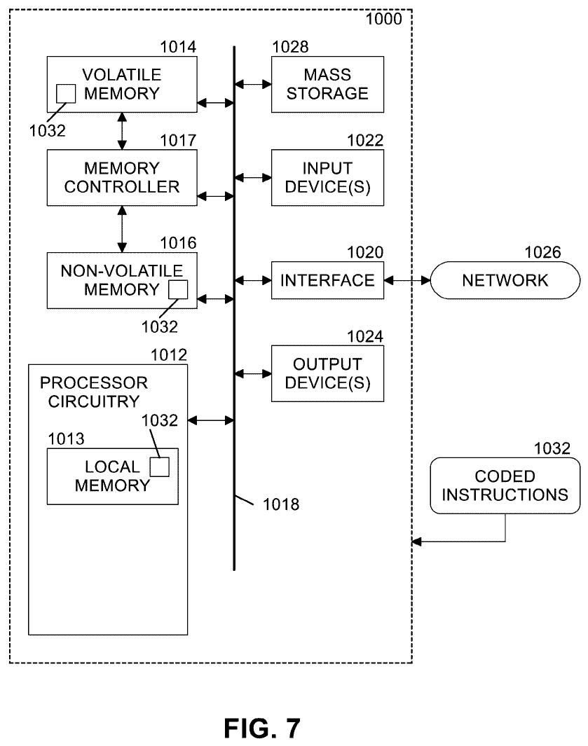

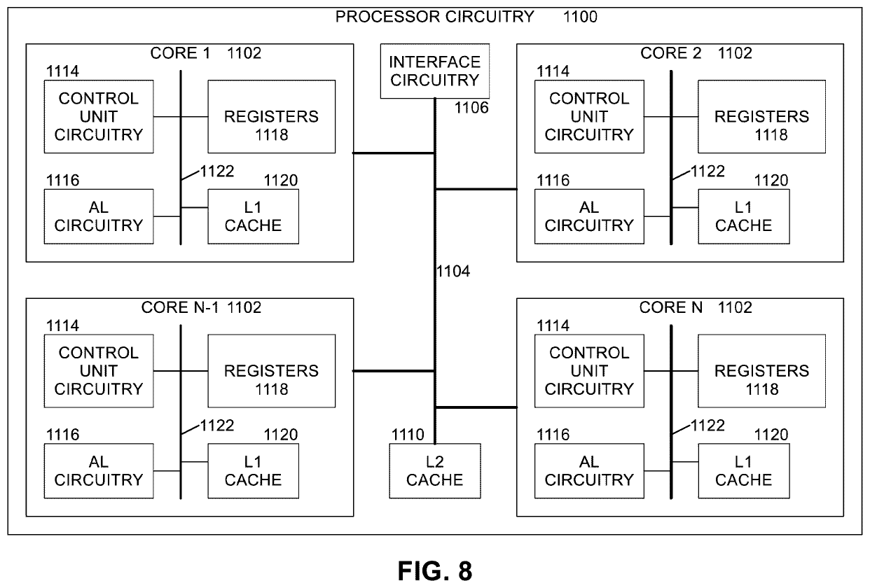

Flowcharts representative of example hardware logic circuitry, machine readable instructions, hardware implemented state machines, and/or any combination thereof for implementing the computing system 200 of FIG. 2 is shown in FIGS. 4-6. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIGS. 8 and/or 9. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The tangible machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 4-6, many other methods of implementing the example computing system 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine-readable instructions may be fragmented and stored on one or more storage devices and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable media, as used herein, may include machine readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a block diagram of an example processor platform 1000 structured to execute and/or instantiate the machine-readable instructions and/or operations of FIGS. 4-6 to implement the apparatus of FIG. 2. In an embodiment, processor platform 1000 is an example of hardware resources 216 of FIG. 2. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the example processor circuitry 122.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1032, which may be implemented by the machine-readable instructions of FIGS. 4-6, may be stored in the mass storage device 1028, in the volatile memory 1014, in the non-volatile memory 1016, and/or on a removable non-transitory computer readable storage medium such as a CD or DVD.

FIG. 8 is a block diagram of an example implementation of the processor circuitry 1012 of FIG. 7. In this example, the processor circuitry 1012 of FIG. 8 is implemented by a microprocessor 1100. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all the machine-readable instructions and/or operations represented by the flowcharts of FIGS. 4-6.

The cores 1102 may communicate by an example bus 1104. In some examples, the bus 1104 may implement a communication bus to effectuate communication associated with one(s) of the cores 1102. For example, the bus 1104 may implement at least one of an Inter-Integrated Circuit (I2C) bus, a Serial Peripheral Interface (SPI) bus, a PCI bus, or a PCIe bus. Additionally or alternatively, the bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2_cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache in local memory 1120, and an example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer-based operations. In other examples, the AL circuitry 1116 also performs floating point operations. In yet other examples, the AL circuitry 1116 may include first AL circuitry that performs integer-based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 8. Alternatively, the registers 1118 may be organized in any other arrangement, format, or structure including distributed throughout the core 1102 to shorten access time. The bus 1104 may implement at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general-purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

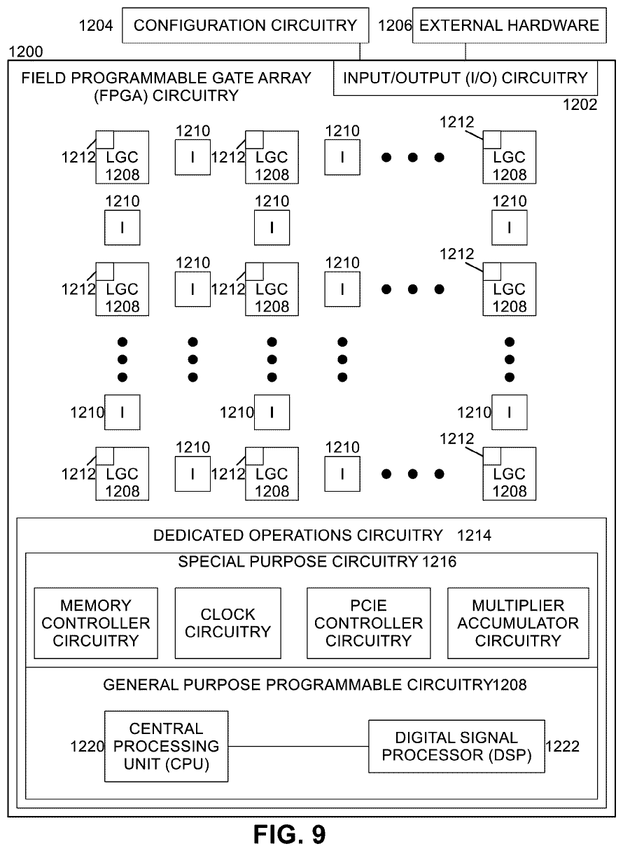

FIG. 9 is a block diagram of another example implementation of the processor circuitry 1012 of FIG. 7. In this example, the processor circuitry 1012 is implemented by FPGA circuitry 1200. The FPGA circuitry 1200 can be used, for example, to perform operations that could otherwise be performed by the example microprocessor 1100 of FIG. 8 executing corresponding machine-readable instructions. However, once configured, the FPGA circuitry 1200 instantiates the machine-readable instructions in hardware and, thus, can often execute the operations faster than they could be performed by a general purpose microprocessor executing the corresponding software.

More specifically, in contrast to the microprocessor 1100 of FIG. 8 described above (which is a general purpose device that may be programmed to execute some or all of the machine readable instructions represented by the flowcharts of FIGS. 4-6 but whose interconnections and logic circuitry are fixed once fabricated), the FPGA circuitry 1200 of the example of FIG. 9 includes interconnections and logic circuitry that may be configured and/or interconnected in different ways after fabrication to instantiate, for example, some or all of the machine readable instructions represented by the flowcharts of FIGS. 4-6. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowcharts of FIGS. 4-6. As such, the FPGA circuitry 1200 may be structured to effectively instantiate some or all of the machine-readable instructions of the flowcharts of FIGS. 4-6 as dedicated logic circuits to perform the operations corresponding to those software instructions in a dedicated manner analogous to an ASIC. Therefore, the FPGA circuitry 1200 may perform the operations corresponding to the some or all of the machine-readable instructions of FIGS. 4-6 faster than the general-purpose microprocessor can execute the same.

In the example of FIG. 9, the FPGA circuitry 1200 is structured to be programmed (and/or reprogrammed one or more times) by an end user by a hardware description language (HDL) such as Verilog. The FPGA circuitry 1200 of FIG. 9, includes example input/output (I/O) circuitry 1202 to obtain and/or output data to/from example configuration circuitry 1204 and/or external hardware (e.g., external hardware circuitry) 1206. For example, the configuration circuitry 1204 may implement interface circuitry that may obtain machine readable instructions to configure the FPGA circuitry 1200, or portion(s) thereof. In some such examples, the configuration circuitry 1204 may obtain the machine-readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may implement the microprocessor 1100 of FIG. 8. The FPGA circuitry 1200 also includes an array of example logic gate circuitry 1208, a plurality of example configurable interconnections 1210, and example storage circuitry 1212. The logic gate circuitry 1208 and interconnections 1210 are configurable to instantiate one or more operations that may correspond to at least some of the machine-readable instructions of FIGS. 4-6 and/or other desired operations. The logic gate circuitry 1208 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 9 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 8 and 9 illustrate two example implementations of the processor circuitry 1012 of FIG. 7, many other approaches are contemplated. For example, as mentioned above, modern FPGA circuitry may include an on-board CPU, such as one or more of the example CPU 1220 of FIG. 9. Therefore, the processor circuitry 1012 of FIG. 7 may additionally be implemented by combining the example microprocessor 1100 of FIG. 8 and the example FPGA circuitry 1200 of FIG. 9. In some such hybrid examples, a first portion of the machine-readable instructions represented by the flowcharts of FIGS. 4-6 may be executed by one or more of the cores 1102 of FIG. 8 and a second portion of the machine-readable instructions represented by the flowcharts of FIGS. 4-6 may be executed by the FPGA circuitry 1200 of FIG. 9.

In some examples, the processor circuitry 1012 of FIG. 7 may be in one or more packages. For example, the processor circuitry 1100 of FIG. 8 and/or the FPGA circuitry 1200 of FIG. 9 may be in one or more packages. In some examples, an XPU may be implemented by the processor circuitry 1012 of FIG. 7, which may be in one or more packages. For example, the XPU may include a CPU in one package, a DSP in another package, a GPU in yet another package, and an FPGA in still yet another package.

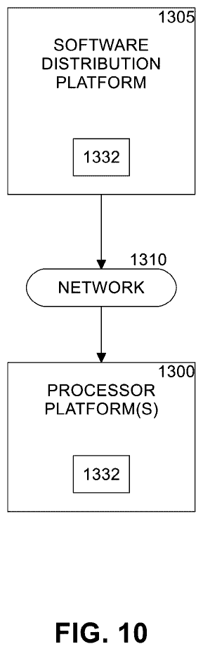

A block diagram illustrating an example software distribution platform 1305 to distribute software such as the example machine readable instructions 1032 of FIG. 7 to hardware devices owned and/or operated by third parties is illustrated in FIG. 10. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 7. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine-readable instructions 1032, which may correspond to the example machine readable instructions, as described above. The one or more servers of the example software distribution platform 1305 are in communication with a network 1310, which may correspond to any one or more of the Internet and/or any of the example networks, etc., described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1032 from the software distribution platform 1305. For example, the software, which may correspond to the example machine readable instructions described above, may be downloaded to the example processor platform 1300, which is to execute the machine-readable instructions 1032 to implement the methods described above and associated computing system 200. In some examples, one or more servers of the software distribution platform 1305 periodically offer, transmit, and/or force updates to the software (e.g., the example machine readable instructions 1032 of FIG. 7) to ensure improvements, patches, updates, etc., are distributed and applied to the software at the end user devices.

In some examples, an apparatus includes means for processing OS 201 and/or firmware 214 of FIG. 2. For example, the means for processing may be implemented by processor circuitry, processor circuitry, firmware circuitry, etc. In some examples, the processor circuitry may be implemented by machine executable instructions executed by processor circuitry, which may be implemented by the example processor circuitry 1012 of FIG. 7, the example processor circuitry 1100 of FIG. 8, and/or the example Field Programmable Gate Array (FPGA) circuitry 1200 of FIG. 9. In other examples, the processor circuitry is implemented by other hardware logic circuitry, hardware implemented state machines, and/or any other combination of hardware, software, and/or firmware. For example, the processor circuitry may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

From the foregoing, it will be appreciated that example systems, methods, apparatus, and articles of manufacture have been disclosed that provide improved system updates. The disclosed systems, methods, apparatus, and articles of manufacture improve the efficiency of using a computing device by determining availability of resources needed to update firmware and/or software in a computing system; updating the firmware and/or software in the computing system when the resources are available; and deferring updating the firmware and/or software when the resources are not available. The disclosed systems, methods, apparatus, and articles of manufacture are accordingly directed to one or more improvement(s) in the operation of a machine such as a computer or other electronic and/or mechanical device.

The following examples pertain to further embodiments. Specifics in the examples may be used anywhere in one or more embodiments. Example 1 is a method including getting a system update configuration for managing updating of at least one of a software component and a firmware component of a computing system powered by a battery; determining an estimated system update time of usage of the battery to update the at least one of the software component and the firmware component based at least in part on the system update configuration; updating the at least one of the software component and the firmware component when resource requirements of the system update configuration are met and the estimated system update time is less than or equal to a minimum remaining time of usage of the battery; and deferring updating the at least one of the software component and the firmware component when the resource requirements of the system update configuration are not met or the estimated system update time is greater than the minimum remaining time of usage of the battery.

In Example 2, the subject matter of Example 1 can optionally include getting the system update configuration from an updater package obtained from a system update repository coupled to the computing system by a network. In Example 3, the subject matter of Example 2 can optionally include wherein the estimated system update time comprises a time to download the updater package and a time to perform the update of the at least one software component and the firmware component. In Example 4, the subject matter of Example 2 can optionally include wherein the updater package comprises updated firmware to replace firmware in the firmware component and the firmware component is a basic input/output system (BIOS). In Example 5, the subject matter of Example 4 wherein the updater package comprises updated firmware to replace firmware in the firmware component and the firmware component is a device of the computing system. In Example 6, the subject matter of Example 2 can optionally include wherein the updater package comprises updated software to replace software in the software component and the software component is at least a portion of an operating system (OS). In Example 7, the subject matter of Example 2 can optionally include wherein the resource requirements comprise cellular communications needed to get the updater package. In Example 8, the subject matter of Example 2 can optionally include wherein the resource requirements comprise WiFi communications needed to get the updater package. In Example 9, the subject matter of Example 1 can optionally include verifying performance of the updating of the at least one the software component and the firmware component and saving the system update configuration. In Example 10, the subject matter of Example 2 can optionally include updating updater metadata of the updater package based at least in part on performance of the updating of at least one of the software component and the firmware component and sending the updated updater metadata to the system update repository.

Example 11 is at least one tangible machine-readable non-transitory medium comprising a plurality of instructions that in response to being executed by a processor cause the processor to: get a system update configuration for managing updating of at least one of a software component and a firmware component of a computing system powered by a battery; determine an estimated system update time of usage of the battery to update the at least one of the software component and the firmware component based at least in part on the system update configuration; update the at least one of the software component and the firmware component when resource requirements of the system update configuration are met and the estimated system update time is less than or equal to a minimum remaining time of usage of the battery; and defer updating the at least one of the software component and the firmware component when the resource requirements of the system update configuration are not met or the estimated system update time is greater than the minimum remaining time of usage of the battery.

In Example 12 the subject matter of Example 11 can optionally include a plurality of instructions that in response to being executed by a processor cause the processor to: get the system update configuration from an updater package obtained from a system update repository coupled to the computing system by a network. In Example 13 the subject matter of Example 12 can optionally include wherein the estimated system update time comprises a time to download the updater package and a time to perform the update of the at least one software component and the firmware component. In Example 14 the subject matter of Example 12 can optionally include wherein the updater package comprises updated firmware to replace firmware in the firmware component and the firmware component is a basic input/output system (BIOS). In Example 15 the subject matter of Example 14 can optionally include wherein the updater package comprises updated firmware to replace firmware in the firmware component and the firmware component is a device of the computing system.

Example 16 is a computing system comprising: a battery; and a processor powered by the battery, the processor to get a system update configuration for managing updating of at least one of a software component and a firmware component; determine an estimated system update time of usage of the battery to update the at least one of the software component and the firmware component based at least in part on the system update configuration; update the at least one of the software component and the firmware component when resource requirements of the system update configuration are met and the estimated system update time is less than or equal to a minimum remaining time of usage of the battery; and defer updating the at least one of the software component and the firmware component when the resource requirements of the system update configuration are not met or the estimated system update time is greater than the minimum remaining time of usage of the battery.

In Example 17, the subject matter of Example 16 can optionally include getting the system update configuration from an updater package obtained from a system update repository coupled to the computing system by a network. In Example 18, the subject matter of Example 17 can optionally include wherein the estimated system update time comprises a time to download the updater package and a time to perform the update of the at least one software component and the firmware component. In Example 19, the subject matter of Example 16 can optionally include wherein the updater package comprises updated firmware to replace firmware in the firmware component and the firmware component is a basic input/output system (BIOS). In Example 20, the subject matter of Example 19 can optionally include wherein the updater package comprises updated firmware to replace firmware in the firmware component and the firmware component is a device of the computing system. Example 21 is an apparatus operative to perform the method of any one of Examples 1 to 10. Example 22 is an apparatus that includes means for performing the method of any one of Examples 1 to 10. Example 23 is an apparatus that includes any combination of modules and/or units and/or logic and/or circuitry and/or means operative to perform the method of any one of Examples 1 to 10. Example 24 is an optionally non-transitory and/or tangible machine-readable medium, which optionally stores or otherwise provides instructions that if and/or when executed by a computer system or other machine are operative to cause the machine to perform the method of any one of Examples 1 to 10.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the examples of this patent.

What is claimed is:

1. A computing device powered by a battery, the computing device comprising:
processing circuitry coupled to a memory, the processing circuitry to:
receive, over a network, an updater package from a system update repository, wherein the updater package includes information identifying resources associated with one or more software update behaviors of one or more software components; and
update the one or more software components using the resources and based on power or battery life associated with the battery.

2. The computing device of claim 1, wherein the updating of the one or more software components is managed by a platform Trusted Execution Environment (TEE) of the computing device.

3. The computing device of claim 1, wherein the resources comprise communication resources including the network having one or more of a cellular communication network or a Wi-Fi communication network.

4. A method facilitated by a computing device powered a battery, the method comprising:
receiving, over a network, an updater package from a system update repository, wherein the updater package includes information identifying resources associated with one or more software update behaviors of one or more software components; and
updating the one or more software components using the resources and based on power or battery life associated with the battery.

5. The method of claim 4, wherein the updating of the one or more software components is managed by a platform Trusted Execution Environment (TEE) of the computing device.

6. The method of claim 4, wherein the resources comprise communication resources including the network having one or more of a cellular communication network or a Wi-Fi communication network.

7. At least one computer-readable medium having stored thereon instructions which, when executed, cause a computing device powered a battery to perform operations comprising:
receiving, over a network, an updater package from a system update repository, wherein the updater package includes information identifying resources associated with one or more software update behaviors of one or more software components; and
updating the one or more software components using the resources and based on power or battery life associated with the battery.

8. The computer-readable medium of claim 7, wherein the updating of the one or more software components is managed by a platform Trusted Execution Environment (TEE) of the computing device.

9. The computer-readable medium of claim 7, wherein the resources comprise communication resources including the network having one or more of a cellular communication network or a Wi-Fi communication network.
